(19) United States
(12) Patent Application Publication
(10) Pub. No.: US 2014/0039856 A1
(43) Pub. Date: Feb. 6, 2014

(54) COMPUTER-READABLE STORAGE MEDIUM COMPRISING INSTRUCTIONS FOR A PROCESS MODEL, AND METHOD OF USE

(71) Applicants: Ian James Dabney, Henley-in-Arden (GB); Geoffrey Mark Hook, Henley-in-Arden (GB); Jeremy Aidan Horgan, Henley-in-Arden (GB)

(72) Inventors: Ian James Dabney, Henley-in-Arden (GB); Geoffrey Mark Hook, Henley-in-Arden (GB); Jeremy Aidan Horgan, Henley-in-Arden (GB)

(73) Assignee: LANNER GROUP LIMITED, Henley-in-Arden (GB)

(21) Appl. No.: 13/563,692

(22) Filed: Jul. 31, 2012

(51) Int. Cl. G06G 7/48

(52) U.S. Cl. 703/6

(57) ABSTRACT

A process simulation modeling system is described, in which a computer-readable storage medium contains a model of a process or operation affected by a number of parameters. A process model maintained in a first data structure, and a plurality of process modifications in a second data structure, wherein one or more of the plurality of process modifications relate to the portion of the model of the process that is dependent upon the subset of the plurality of parameters, such that only a change in the subset of the plurality of parameters affect the portion of the model, and wherein the computer is programmably arranged to generate an output representing the effect of the change in the subset of the plurality of parameters on the model of the process.

### BACKGROUND TO THE INVENTION

The invention relates to the field of process modelling as used in process simulation, in which a computer-readable storage medium contains a model of a process or operation, wherein the process or operation is affected by a number of parameters.

Many processes, in particular business processes, are affected by a large number of parameters, some of which are controllable by a process operator.

The various parameters often interact with each other in complex ways, and determining the effect of a change to one parameter upon the whole process is not straightforward.

Prior to the implementation of business process simulation, it was necessary for a process operator to change a parameter of the actual process in order to determine the effect of that change. The change might be advantageous or disadvantageous to the process. Clearly, only changes which were not expected to be damaging to the process could be tested in this way. Also, the process operator would typically only seek to undertake changes which were expected to be advantageous to the process.

Business process simulation, in which a simulation is used to replicate the actual process, can be used to test changes in parameters without affecting the actual process. The process operator can use the simulation to identify the effect of changes to any of the parameters which can be controlled, and any changes which are found to be advantageous can be implemented upon the actual process.

A major advantage of business process simulation is therefore that the user can test changes in parameters, and changes in multiple parameters, which might not have been tested on the actual process. The user can readily test changes which might be disadvantageous or damaging to the process, without causing any detriment or damage to the actual process. It might be, for example, that a simulation reveals that changing a certain combination of parameters is unexpectedly advantageous, the user being unlikely to have tested that combination of parameters on the actual process.

Because of its advantages in allowing a user to identify the effect of changes without affecting the actual process, business process simulation is in widespread use. Because of the complexity involved the simulations are ordinarily carried out by a computer, the simulation designer producing software comprising instructions which are executable by a computer system. The process is usually described in “business process management notation” which is the universally accepted coding for business simulation software.

The process operator can use the simulation software to simulate a change in one or more of the process parameters, whereupon the computer system uses a variety of measures to undertake the necessary calculations in order to determine the effect of that change upon the process.

The simulation software therefore allows the user to test any changes to the parameters before those changes are made to the actual process, and to implement only those changes to the actual process which the simulation indicates will be advantageous to the process.

To be effective the simulation must be configured with: {i} the structure of the process including the parameters which affect the process, {ii} appropriate values for the parameters, and {iii} a simulation routine. The simulation routine is often called the experimental definition, and defines certain features of the simulation procedure. One feature of the experimental definition will typically be the duration of the actual process which is to be simulated. It is necessary to undertake a simulation corresponding to the use of the actual process for a particular period of time in order for the simulation to yield a valid result. The period of time may be a number of minutes, a number of hours, a number of days, or a number of years, depending upon the process. Also, those parameters which are outside the control of the process operator will typically be represented by probability distributions, and another feature of the experimental definition will be the number of replications of the simulation which are required to be undertaken in order to obtain a statistically valid result.

Despite the considerable advantages of business process simulation, it has a significant disadvantage. Specifically, a typical process will be affected by a large number of parameters, and those parameters will interact with each other in numerous and complex ways. To be effective the simulation must therefore be similarly complex, the complexity often obscuring the actual interactions which take place between the various parameters.

Conventionally, if the user wishes to investigate the effect of a modification to the process (such as a change to a particular parameter) for which the simulation is configured, it is necessary to input the values of every parameter into the simulation. Because the user does not know the detail of all of the interactions between the parameters, all of the parameters must be entered before the simulation can be undertaken, even those parameters which are not to be changed. Whilst the failure to enter a particular parameter might not affect the validity of a particular simulation, the user does not know which of the parameters will be relevant, and it is therefore necessary to enter all of the parameters in order to ensure that the simulation is valid.

It is therefore usually time-consuming for the user to use the business process simulation, and the user may not be able to justify using the simulation to investigate minor modifications of the process, and will often only commit the time necessary to investigate major modifications of the process. This results in the user obtaining less than the maximum benefit which is available from the business process simulation. The simulations which are undertaken are also often wasteful of the user's time and of the computer's processing capacity as the user may in practice be inputting parameters which have no effect upon the particular simulation.

### SUMMARY OF THE INVENTION

The inventor has appreciated that it is desirable to avoid the requirement to input unnecessary parameters, resulting in a direct saving in the user's time and effort, and often resulting in an indirect saving in the time taken to complete the simulation. The ability to enter only the parameters which affect the particular simulation is expected to increase the utility of the business process simulation significantly, and thereby increase the benefit of its use to the process operator. Alternatively stated, it is expected that process operators would utilize a business process simulation more often if the simulation were tailored more accurately to the operator's requirements.

According to the invention, there is provided a non-transitory computer-readable storage medium storing instructions executable by a computer system, the non-transitory computer-readable storage medium comprising instructions to:
maintain a model of a process in a first data structure, wherein the model includes a plurality of parameters, and wherein a portion of the model of the process is dependent upon a subset of the plurality of parameters,
   wherein the subset of the plurality of parameters includes one or more of the plurality of parameters but not all of the plurality of parameters;
calculating the model of the process according to a set of initial values of the plurality of parameters;
maintaining a plurality of process modifications in a second data structure, wherein one or more of the plurality of process modifications relate to the portion of the model of the process that is dependent upon the subset of the plurality of parameters, such that only a change in the subset of the plurality of parameters affect the portion of the model;
presenting to a user by way of a user interface the plurality of process modifications;
receiving by way of the user interface a selection of one of the plurality of process modifications;
retrieving from the second data structure the subset of the plurality of parameters that relate to the portion of the model associated with the selected process modification;
prompting the user by way of the user interface for input as to the change in the subset of the plurality of parameters;
upon receiving the change in the subset of parameters, calculating an effect on the model of the process; and
generating an output representing the effect of the change in the subset of the plurality of parameters on the model of the process,
   whereby in investigating changes to one or more of the plurality of parameters, the user is guided by the plurality of process modifications so as to enter only the change in the subset of the plurality of parameters that pertains to the selected process modification.

The second data structure is therefore configured to include a number of modifications which the user might wish to make to the process, and is further configured with data relating to the parameters which affect those modifications.

Preferably, the plurality of process modifications are presented to the user as a plurality of questions relating to the process.

As above indicated, some of the parameters will be controllable and others will not. An example of a controllable parameter would be the number of staff allocated to a particular part of the process. An example of a non-controllable parameter would be the weather.

The process modification which the user can investigate might be a change to a single parameter (such as a change to the number of staff allocated to a particular part of the process). Alternatively, the process modification might be a complex combination of parameters (such as the failure of one part of the process which affects other parts of the process). In each case, the second data structure is configured with data relating to the subset of parameters which affect, or are affected by, each of the identified process modifications.

Since the user might wish to investigate process modifications which affect every controllable parameter, the second data structure is preferably configured with data relating to the effect of changes to each one of the controllable parameters, and the interactions with other parameters. Since each different process modification will typically affect a different portion of the model, there will typically be a different subset of parameters, one subset for each process modification. Preferably therefore, the second data structure includes a plurality of subsets, each of the subsets comprising one or more of the plurality of parameters.

Accordingly, the user can commence a simulation by choosing one of a set of predetermined process modifications which the user might wish to change. The second data structure can be configured to communicate all of the available process modifications to the user interface at once, or the process modifications can be grouped by parameter, or ranked by likelihood of use, the user being guided through the available process modifications in order to identify the process modification which is to be investigated.

When the user has inputted the data to identify the process modification to be investigated, the second data structure is accessed in order to determine the subset of parameters for that process modification, whereupon the user is asked to input values for the subset of parameters.

The values which are inputted for the subset of parameters may comprise initial values and changed values, i.e. the investigation of the process modification might require a change to only one parameter in the subset, or all of the parameters in the subset.

One or more of the parameters in the subset of parameters may interact with one or more of the non-controllable parameters, whereupon the second data structure will include those interactions also. For example, a change to the number of staff allocated to a particular part of the process may have no effect upon the process during the summer months, but might affect the process during the winter months. In such cases, the user will be prompted by the user interface to input the time of year, notwithstanding that the user has no control over that parameter.

It is necessary for the computer to undertake a simulation with the changed parameter(s) and compare that to the simulation with the initial values for each parameter. For some parameter changes, it might be necessary to run only the portion of the simulation which is affected by the change, whereupon the simulation can be run more efficiently. Alternatively, in order to generate a simulation for the changed parameter values to compare with the simulation for the initial parameter values, it might be necessary to run a complete simulation, notwithstanding that only a portion of the model is affected by the changed parameter.

### BRIEF DESCRIPTION OF THE DRAWING

FIG. 1 is a schematic representation of a computer having a computer-readable storage medium according to the present invention.

### DETAILED DESCRIPTION

The present invention relates to the field of process modelling as used in process simulation, in which a computer-readable storage medium contains a model of a process or operation, the process or operation being affected by a number of parameters. The invention provides a non-transitory computer-readable storage medium or memory storing instructions executable by a computer system. The computer: {i} maintains a model of a process in a first data structure, wherein the model includes a plurality of parameters, and wherein a portion of the model of the process is dependent upon a subset of the plurality of parameters, the subset of the plurality of parameters includes one or more of the plurality of parameters but not all of the plurality of parameters; {ii} calculates the model of the process according to a set of initial values of the plurality of parameters; {iii} maintains a plurality of process modifications in a second data structure, wherein one or more of the plurality of process modifications relate to the portion of the model of the process that is dependent upon the subset of the plurality of parameters, such that only a change in the subset of the plurality of parameters affect the portion of the model; {iv} presents to a user by way of a user interface the plurality of process modifications; {v} receives by way of the user interface a selection of one of the plurality of process modifications; {vi} retrieves from the second data structure the subset of the plurality of parameters that relate to the portion of the model associated with the selected process modification; {vii} prompts the user by way of the user interface for input as to the change in the subset of the plurality of parameters; {viii} upon receiving the change in the subset of parameters, calculates an effect on the model of the process; and {ix} generates an output representing the effect of the change in the subset of the plurality of parameters on the model of the process. The invention permits a user to investigate changes to one or more of the plurality of parameters, and guides the user by way of the plurality of process modifications to enter only the change in the subset of the plurality of parameters that pertains to the selected process modification.

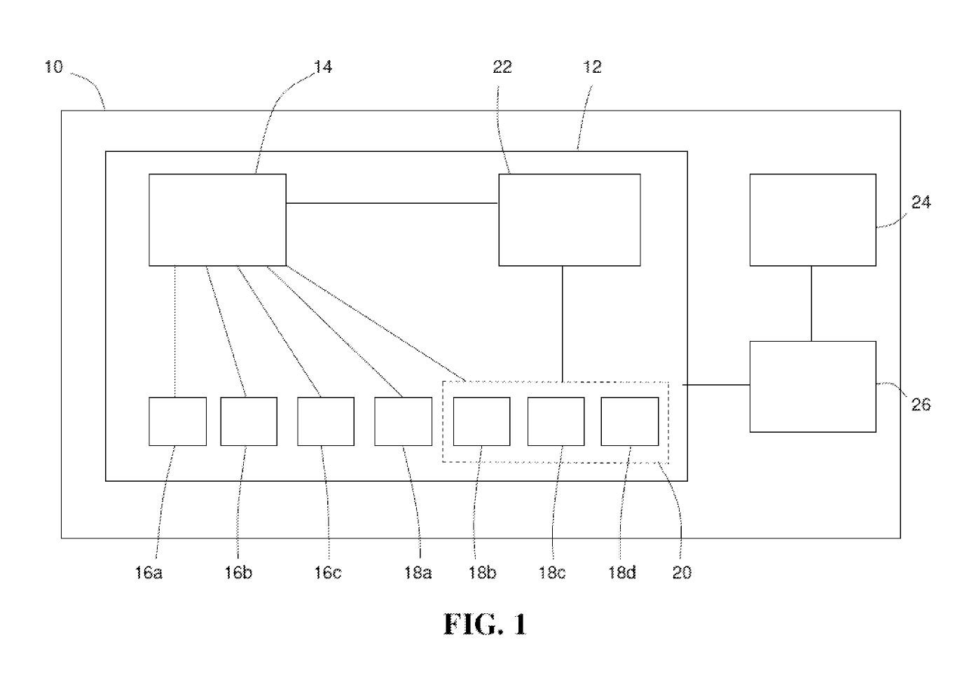

The invention will now be described, by way of example, with reference to the accompanying drawing of FIG. 1, which shows a schematic representation of a computer having a computer-readable storage medium according to the present invention.

The computer 10 represented in FIG. 1 has a non-transitory computer-readable storage medium or memory 12 storing instructions executable by the computer 10. The memory 12 has a first data structure 14 in which are stored instructions to maintain a model of a process.

The model of the process includes a plurality of parameters 16a-c and 18a-d. The parameters 16, 18 are stored within the memory 12 and may in some alternative embodiments be stored within the first data structure 14, but in this embodiment are stored separately.

In this embodiment, the model is dependent upon seven parameters 16, 18, but it will be understood that different embodiments can store models which are dependent upon more or fewer parameters. Also in this embodiment, the model is dependent upon parameters 16a-c which are not controllable by the process operator. The particular model may, for example, be dependent upon the time of year, the weather and the ambient temperature, each of which would be a non-controllable parameter. The model is also dependent upon a number of parameters 18a-d which are all controllable by the process operator. One example of a controllable parameter would be the number of staff allocated to a particular task within the process.

The parameters 18b, 18c and 18d form a subset of the parameters 16, 18, represented by the dotted outline 20. The designer of the model has determined that a particular portion of the model of the process is dependent upon the subset 20 of parameters 18b-d, and that the parameters 16a-c and 18a do not affect that portion of the model.

The memory 12 also includes a second data structure 22 in which is stored one or more process modifications which have been predetermined by the model designer. Significantly, one of the process modifications stored within the second data structure 22 relates to the particular portion of the model which is dependent upon the subset 20 of the parameters 18b-d.

The user interacts with the computer 10 through a user interface 24 by way of control means 26. In a typical computer such as 10 the user interface 24 comprises a display and a keyboard and the control means 26 comprises a microprocessor. The predetermined process modifications are presented to the user, and the user inputs the responses, by way of the user interface 24. The process modifications may be listed upon the user interface for the user to identify the process modification to be investigated. Alternatively, the process modifications might be identified as a series of questions to which the user can supply appropriate answers.

The inputted response is communicated by the control means 26 to the memory 12. The memory 12 identifies, by way of the second data structure 22, the subset 20 of the plurality of parameters 18b-d that affect the portion of the model associated with the selected process modification. Those parameters 18b-d are identified to the user by way of the user interface 24, and the user is asked to input values for each of the parameters 18b-d in the subset 20.

If the process modification which is to be investigated comprises a change in a particular parameter 18b (e.g. a change to the number of staff allocated to a particular part of the process) the parameter 18b is necessarily included within the subset 20. The other parameters 18c and 18d in the subset 20 are those parameters which the model designer has determined will also affect the portion of the model when a change is made to the parameter 18b. The user can be informed of the initial value of each of the parameters 18b-d as presently stored for the model (and perhaps upon which a previous process simulation was based) and can be prompted to increase or decrease each of the parameters 18b-d, or to input a new value for each of those parameters, as desired. The user may wish to change only the parameter 18b, or may change also the parameters 18c and/or 18d.

When the user has inputted a value for each of the subset of parameters 18b-d, the computer 10 can undertake the simulation of the model. Depending upon the simulation which is required, and the change which the user has inputted, the computer may need to execute the whole of the model, or only a part of the model, in order to allow the user to compare the changed process with the initial process, and to determine if the change is advantageous or disadvantageous.

In common with conventional business process simulations, the experimental definition for the simulation will determine the required number of repetitions, and the time period which the simulation represents. The non-controlled parameters 16a-c are often represented by probability distributions and the simulation will typically provide a slightly different result for each repetition, the number of repetitions being determined so as to provide a statistically valid result.

Importantly, the experimental definition is determined by the model designer and cannot io be changed by the user. The same experimental definition is therefore used for every similar simulation and the effect of the change(s) in the parameter(s) 18b-d can be directly compared with the simulation of the process using the initial parameter values.

It will be understood that each controllable parameter 18 will interact with the other parameters 16, 18 in different ways. Accordingly, the parameters which form the subset 20 in relation to one process modification will not be the same subset of parameters for a different process modification.

In the present embodiment for example, the subset 20 of the parameters 18b-d might be those parameters which interact with the parameter 18b. Alternatively stated, any change to parameter 18b does not affect the parameters 16a-c or 18a and so those parameters are not included in the subset 20. It will be understood that a different process modification will have a different subset stored within the second data structure 22, which could include one or more of the parameters 16a-c and/or one or more of the parameters 18a-d. The various subsets of parameters for each process modification will be determined by the designer of the model and stored in the second data structure 22.

### EXAMPLE

The present invention might be used to simulate the operation of a commercial café, for which the key business process measure is the flow rate of customers being served with their chosen food and/or drink. The model of the process which is stored in the memory 12 therefore represents the steps which each customer undergoes between arrival at and departure from the café.

The flow rate of customers is affected by several parameters which are within the control of the process operator, including the number of personnel clearing tables (18a), the number of tables at which customers can sit (18b), the number of tills at which customers can pay (18c) and the number of food choices which are available (18d). (There will be several additional controllable parameters for such a process, but the number of controllable parameters has been limited to four to correspond to the drawing.)

The flow rate of customers is also dependent upon a number of parameters which the process operator cannot control, such as the time of day (16a), the day of the week (16b) and the weather (16c). (Again, there will be other non-controllable parameters in practice).

The computer-readable storage medium 12 is configured with all of these non-controllable parameters 16a-c, and all of these controllable parameters 18a-d, and all of the interactions between these parameters which affect the flow rate of customers.

In conventional fashion, the computer 10 can use the model of the process which is stored in the first data structure 14 to calculate the flow rate of customers dependent upon initial values for each of the parameters 18 inputted by the user.

The computer 10 can also use the model to calculate the flow rate of customers when one or more of the parameters 18 are changed from their initial values. With a conventional business process simulation the user must input values for each of the parameters 18 in order to undertake a comparative simulation, even those values which are not to be changed, since the user will not know the way in which each of the parameters affects the other parameters.

With the present invention on the other hand, the second data structure 22 contains data relating to the process modifications which the user can investigate, and includes data relating to the subsets of parameters which affect the process when those modifications are made.

For example, the process operator can control the number of tills at which the customer can pay. In practice, the number of tills (parameter 18c) might be relevant to the flow rate of customers during times for which the café is busy, but might not be relevant to the flow rate when the café has very few customers. Also, the number of tills might affect the flow rate of customers if a large proportion of customers are ordering drinks only, but might not affect the flow rate of customers if a large proportion are ordering food. The number of tills (parameter 18c) will therefore interact with the other controllable parameters 18, and also with the non-controllable parameters 16, in complex ways, all of which interactions can be stored in the second data structure 22.

In this example, the user might wish to simulate changing the process by adding an additional till. The model has been designed for this possibility, and one of the available process modifications presented upon the user interface 24 is “Do you wish to change the number of tills?” If the user responds positively to this question, the second data structure 22 is accessed and the subset of parameters which have an effect upon the flow rate of customers when the number of tills is changed, is identified. The user is prompted to input values for each of that subset of parameters.

All or part of the simulation is then run, and the flow rate of customers can be compared with the flow rate generated by the simulation with the initial parameter values (i.e. the initial number of tills). Depending upon the parameter (or parameters) which has been changed, it might not be necessary for the whole of the simulation to be repeated, and the first data structure 14 can use the results of previous parts of the simulation if they have not changed. However, the avoidance of repetition of some parts of the simulation is a possible secondary advantage of the present invention. The primary advantage is that the user only has to input values for the subset 20 of parameters rather than for all parameters. For more complex processes having a large number of parameters, the present invention is expected to represent a significant reduction in time and effort for the user, leading to a likely increase in utilisation of the business process simulation.

For a business process simulation of a commercial cafe, the parameters might for example include: {a} the number of customers in a wave of customer arrivals, {b} the duration of a wave of customer arrivals, {c} the period between waves of customer arrivals, {d} the number of cleaning locations within the cafe (e.g. sinks), {e} the number of cutlery/tray locations, {f} the period of time taken by a customer to collect a tray and cutlery, {g} the number and type of food choices available (both staffed and self-service), {h} the service duration for each food choice, {i} an identification of the customer routes through the food choices, {j} the payment options available to customers and the duration of payment for each option, {k} the frequency and duration of payment problems, {l} the number of customer seating locations, {m} the duration of customer service, {n} the duration of customer mealtimes, and {o} the duration of customer returns. Some of these parameters will be represented by actual numbers, whereas others will be represented as probability distributions.

For a commercial cafe three possible process modifications which might be presented upon the user interface 24 (in this embodiment as questions) include “What if the number of seating locations changed?”, “What if more customer routes through the food choices are made available?, and “What if there is an increase in vegetarians?” for example.

What is claimed is:

1. A non-transitory computer-readable storage medium storing instructions executable by a computer system, the non-transitory computer-readable storage medium comprising instructions to:
maintain a model of a process in a first data structure, wherein the model includes a plurality of parameters, and wherein a portion of the model of the process is dependent upon a subset of the plurality of parameters,
wherein the subset of the plurality of parameters includes one or more of the plurality of parameters but not all of the plurality of parameters;
calculating the model of the process according to a set of initial values of the plurality of parameters;
maintaining a plurality of process modifications in a second data structure, wherein one or more of the plurality of process modifications relate to the portion of the model of the process that is dependent upon the subset of the plurality of parameters, such that only a change in the subset of the plurality of parameters affect the portion of the model;
presenting to a user by way of a user interface the plurality of process modifications;
receiving by way of the user interface a selection of one of the plurality of process modifications;
retrieving from the second data structure the subset of the plurality of parameters that relate to the portion of the model associated with the selected process modification;
prompting the user by way of the user interface for input as to the change in the subset of the plurality of parameters;
upon receiving the change in the subset of parameters, calculating an effect on the model of the process; and
generating an output representing the effect of the change in the subset of the plurality of parameters on the model of the process,
whereby in investigating changes to one or more of the plurality of parameters, the user is guided by the plurality of process modifications so as to enter only the change in the subset of the plurality of parameters that pertains to the selected process modification.

2. The non-transitory computer-readable storage medium according to claim 1, wherein the plurality of process modifications are presented to the user as a plurality of questions relating to the process.

3. The non-transitory computer-readable storage medium according to claim 1, wherein at least one of said plurality of parameters is a controllable parameter.

4. The non-transitory computer-readable storage medium according to claim 1, wherein at least one of said plurality of parameters is a non-controllable parameter.

5. The non-transitory computer-readable storage medium according to claim 4, wherein said plurality of process modifications comprises a change to each one of said plurality of parameters which is controllable.

6. The non-transitory computer-readable storage medium according to claim 1, wherein the second data structure includes a plurality of different subsets of the plurality of parameters, each of the subsets comprising one or more of the plurality of parameters.

7. The non-transitory computer-readable storage medium according to claim 1, wherein at least one of said plurality of process modifications comprises a change to a single one of said plurality of parameters.

8. The non-transitory computer-readable storage medium according to claim 1, wherein at least one of said plurality of process modifications comprises a combination of at least two of said plurality of parameters.

9. A method of use of the non-transitory computer-readable storage medium according to claim 1, comprising the steps of:
identifying a process modification from the plurality of process modifications;
accessing the second data structure to identify the subset of the plurality parameters for that process modification;
presenting the subset of the plurality of parameters by way of the user interface;
inputting values for each of the parameters within the subset of the plurality of parameters;
calculating the model of the process dependent upon the inputted values; and
generating an output representing the effect of the change in the subset of the plurality of parameters on the model of the process.

10. The method of use according to claim 9 in which the step of calculating the model of the process comprises combining data from a previous calculation of the model with data from the portion of the model of the process which is dependent upon the subset of the plurality of parameters.
